(19) United States
(12) Patent Application Publication
(10) Pub. No.: US 2026/0258926 A1
(43) Pub. Date: Sep. 3, 2026

(54) VEHICLE LAMP MODULE, MOTOR VEHICLE HEADLAMP AND MOTOR VEHICLE

(71) Applicant: VALEO VISION, Bobigny (FR)

(72) Inventors: Lu BAI, Bobigny (FR); Lin CHEN, Bobigny (FR)

(73) Assignee: VALEO VISION, Bobigny (FR)

(21) Appl. No.: 18/687,005

(22) PCT Filed: Aug. 25, 2022
(86) PCT No.: PCT/EP2022/073731

§ 371 Date: Feb. 27, 2024

(30) Foreign Application Priority Data
Aug. 31, 2021 (CN) 202122090169.9

(51) Int. Cl. F21S 41/43; F21S 41/147; F21S 41/151; F21S 41/25; F21S 41/32; F21S 41/47; F21S 45/47; F21W 102/13

(52) U.S. Cl. CPC F21S 41/43; F21S 41/147; F21S 41/151; F21S 41/25; F21S 41/321; F21S 41/47; F21S 45/47; F21W 2102/13

(57) ABSTRACT

The present invention relates to a vehicle lamp module, which includes a light source, a reflector, a lens, and a radiator, with the reflector being arranged opposite the light source, and the reflector has a reflective surface for reflecting the light rays emitted by the light source to form a light beam along an optical axis of the vehicle lamp module. The lens is adjacent to the reflector for projecting the light rays reflected by the reflector. The light source is arranged on the radiator, and the radiator dissipates heat from the light source. The vehicle lamp module also includes a light blocker. The present invention also provides a motor vehicle headlamp comprising the vehicle lamp module, and a corresponding motor vehicle.

### TECHNICAL FIELD

The present invention relates to a vehicle lamp module, a motor vehicle headlamp and a motor vehicle.

### BACKGROUND OF THE INVENTION

In the field of motor vehicle lighting, since a focal point of a lens is close to a light source, light rays directly emitted by the light source may be projected outwardly through the lens, resulting in colored over-bright spots in a low-beam area or colored spots in a high-beam area.

### SUMMARY OF THE INVENTION

Therefore, an objective of the present invention is to provide a vehicle lamp module and a motor vehicle, which can at least partially solve the technical problems mentioned above.

A vehicle lamp module according to the present invention comprises: a light source, a reflector, a radiator, and a lens, wherein the light source is arranged on the radiator, and the radiator dissipates heat from the light source; the reflector is arranged opposite to the light source, and the reflector has a reflective surface for reflecting light rays emitted by the light source to form a light beam along an optical axis of the vehicle lamp module; the lens is configured to project the light rays reflected by the reflector; and the vehicle lamp module further comprises a light blocker.

According to a non-limiting embodiment of the present invention, the light blocker is arranged between the light source and the lens.

According to a non-limiting embodiment of the present invention, the light blocker is arranged on the radiator.

According to a non-limiting embodiment of the present invention, the light blocker and the radiator are of an integral structure.

According to a non-limiting embodiment of the present invention, the light blocker is arranged in one-to-one correspondence with the light source.

According to a non-limiting embodiment of the present invention, when the vehicle lamp module comprises a plurality of light sources, the light blocker is shared by more than one of the light sources.

According to a non-limiting embodiment of the present invention, the surface of the light blocker close to the light source is a flat surface or a stepped surface.

The present invention also provides a motor vehicle headlamp, comprising the vehicle lamp module described above.

The present invention also provides a motor vehicle, comprising the vehicle lamp module or motor vehicle headlamp described above.

### BRIEF DESCRIPTION OF THE DRAWINGS

The present invention is further explained below with the aid of the accompanying drawings, in which

FIG. 1 is a schematic diagram of a vehicle lamp module according to an embodiment of the present invention;

FIG. 2 shows a structure of a light blocker according to an embodiment of the present invention;

FIG. 3 shows another structure of a light blocker according to an embodiment of the present invention; and

FIGS. 4a, 4b, 4c, and 4d are comparison diagrams of the light effects of a vehicle lamp module according to an embodiment of the present invention and a vehicle lamp module without a light blocker.

### DETAILED DESCRIPTION OF THE INVENTION

Embodiments of the present invention are exemplified below. As those skilled in the art should realize, the embodiments described may be modified in various ways without departing from the concept of the present invention. Thus, the accompanying drawings and the description are in essence demonstrative and non-limiting. In the following text, identical reference numerals generally denote elements with identical or similar functions.

The present invention provides a vehicle lamp module, a motor vehicle headlamp comprising the vehicle lamp module, and a motor vehicle.

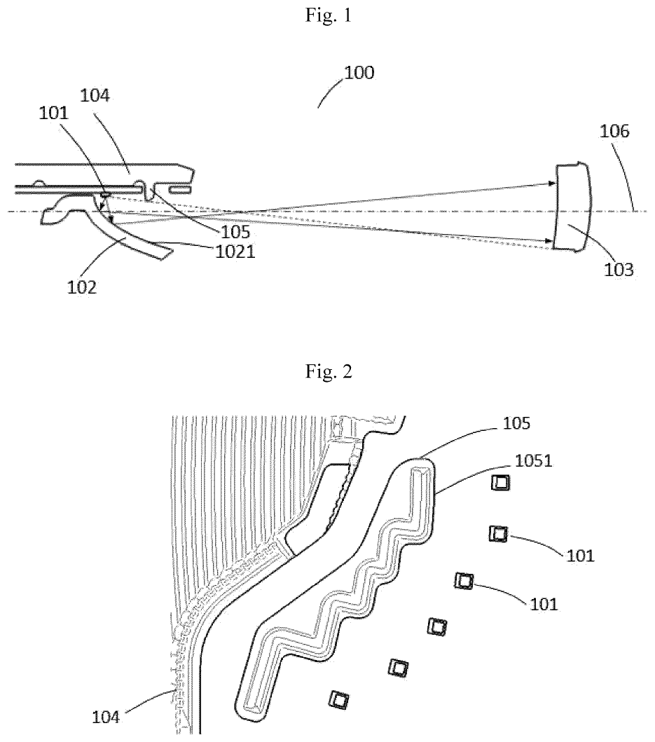

FIG. 1 schematically shows a schematic diagram of a vehicle lamp module 100 according to an embodiment of the present invention. The vehicle lamp module 100 comprises: a light source 101, a reflector 102, a lens 103, and a radiator 104. The light source 101 emits light rays. The reflector 102 is arranged opposite to the light source 101, and the reflector 102 has a reflective surface 1021 for reflecting the light rays emitted by the light source 101 to form a light beam along an optical axis 106 of the vehicle lamp module 100. The lens 103 is configured to project the light rays reflected by the reflector 102. The light source 101 is arranged on the radiator 104, and the radiator 104 dissipates heat from the light source 101.

According to a preferred embodiment of the present invention, the light source 101 is advantageously a semiconductor light source, such as a light-emitting diode (LED). According to another preferred embodiment of the present invention, the light source 101 is a printed circuit board (PCB) with a semiconductor light source.

In a half-space bounded by a principal plane of the light source 101, the light source 101 emits the light rays in a principal direction perpendicular to the principal plane and the optical axis 106.

A main body of the reflector 102 is in the shape of a shell or a cap. An inner surface of the main body of the reflector 102 is the reflective surface 1021. The reflective surface 1021 advantageously has an elliptical or parabolic profile. The reflector 102 is preferably made of a material with good heat resistance, such as glass or a polymer such as polycarbonate (PC).

The light source 101 is preferably arranged at a focal point of the reflective surface 1021 of the reflector 102, such that the light rays emitted by the light source 101 are received and reflected by the reflective surface 1021 of the reflector 102 to form a light beam along the optical axis 106.

The lens 103 is an optical device capable of transmitting the light rays, which projects the light rays incident on the lens 103 to form a desired beam pattern.

The radiator 104 is connected to the reflector 102 and the lens 103, and provides support for the light source 101 while dissipating heat from the light source 101.

The vehicle lamp module 100 according to the present invention further comprises a light blocker 105. As shown in FIG. 1, the light blocker 105 is arranged between the light source 101 and the lens 103. The light blocker 105 blocks the light rays emitted by the light source 101 that are parallel or substantially parallel to the optical axis 106, so as to prevent the light rays from being projected through the lens 103 in an undesired manner.

The light blocker 105 is preferably opaque to absorb the light rays directly emitted by the light source 101 towards the lens 103. The light blocker 105 comprises a front face 1051 and another face opposite to the front face 1051, wherein the front face 1051 is the face close to the light source 101. In an embodiment, the front face 1051 absorbs the light rays directly emitted by the light source 101 towards the lens 103. In another embodiment, the front face 1051 may also reflect the light rays directly emitted by the light source 101 towards the lens 103.

According to an embodiment of the present invention, the light blocker 105 is arranged on the radiator 104. By arranging the light blocker 105 on the radiator 104 in a direction in which the light source 101 directly emits the light rays to the lens 103, it is possible to avoid occupying the limited space in the vehicle lamp module 100 and achieve a more compact structure.

More preferably, the light blocker 105 and the radiator 104 are integrally formed with each other, so as to reduce the use of mounting elements and thus reduce the assembly complexity.

In order to ensure the heat dissipation effect of the light source 101 and facilitate the wiring of the light source 101, there is a certain distance between the light blocker 105 and the light source 101. Preferably, the distance between the light blocker 105 and the light source 101 is about 4-4.5 mm.

The light blocker 105 has a certain height and width to achieve a better blocking effect.

The width (dimension in a length direction of the lens 103) of the light blocker 105 depends on the length of the lens 103, and the height (i.e., the height protruding from the radiator 103) of the light blocker 105 depends on the width of the lens 103. The size of the light blocker 105 may be determined according to the specific applicable situation, and will not be specifically limited in the present invention.

According to an embodiment of the present invention, the light blocker 105 is arranged in one-to-one correspondence with the light source 101. Each light blocker 105 absorbs or reflects the light rays directly emitted by its corresponding light source 101.

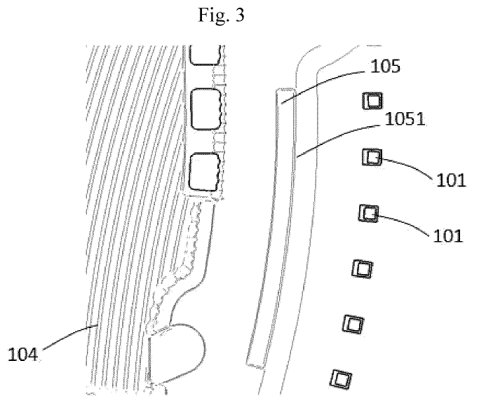

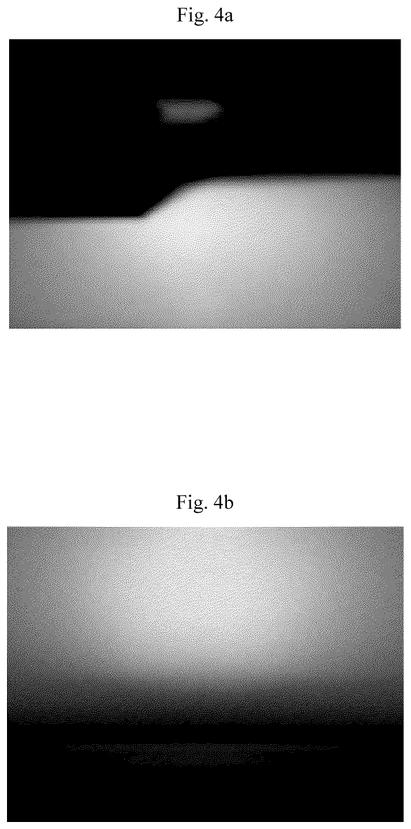

In order to ensure a good lighting effect, the vehicle lamp module 100 generally comprises a plurality of light sources 101. According to a preferred embodiment of the present invention, as shown in FIGS. 2 and 3, when the vehicle lamp module 100 comprises a plurality of light sources 101, the light blocker 105 is shared by more than one of the light sources 101. That is, one light blocker 105 can block (including absorb, reflect, etc.) the light rays directly emitted by multiple light sources 101 in the direction of the lens 103. The complexity of the manufacturing process can be reduced by reducing the number of light blockers 105.

Depending on the requirements of the lighting effect of the vehicle lamp module 100, the plurality of light sources 101 may have different arrangements. Considering that a corresponding distance needs to be ensured between the light blocker 105 and the light sources 101, the surface of the light blocker 105 close to the light source 101, that is, the front face 1051 of the light blocker 105, may be implemented in different shapes according to actual requirements.

FIG. 2 shows a structure of a light blocker according to an embodiment of the present invention. As shown in FIG. 2, when the plurality of light sources 101 have gradually reducing or decreasing distances from the lens 103, the front face 1051 of the light blocker 105 is correspondingly stepped.

FIG. 3 shows another structure of a light blocker according to an embodiment of the present invention. As shown in FIG. 3, when the plurality of light sources 101 have approximately the same distances from the lens 103, the front face 1051 of the light blocker 105 is correspondingly a flat face.

The stepped or flat front face 1051 of the light blocker 105 is only used as an example to illustrate the shape of the light blocker 105, and does not constitute a specific limitation thereof. In other embodiments, the front face 1051 of the light blocker 105 may have other shapes. For example, when the light sources 101 are arranged in an arc shape, the front face 1051 of the light blocker 105 is arc-shaped.

According to an embodiment of the present invention, the light blocker 105 and the radiator 104 may be stamped or machined into a one-piece integral configuration from a conventional material (e.g., aluminum or other suitable metal materials). However, it should also be understood that the radiator 104 may be made of other materials or by means of other processes, which will not be specifically limited in the present invention.

Although FIG. 1 of the present invention only schematically shows a high-beam path of the vehicle lamp module 100, those skilled in the art know a low-beam path of the vehicle lamp module 100 on this basis. Therefore, although the low-beam situation is not described in detail in the present invention, its corresponding content is still covered by the present invention.

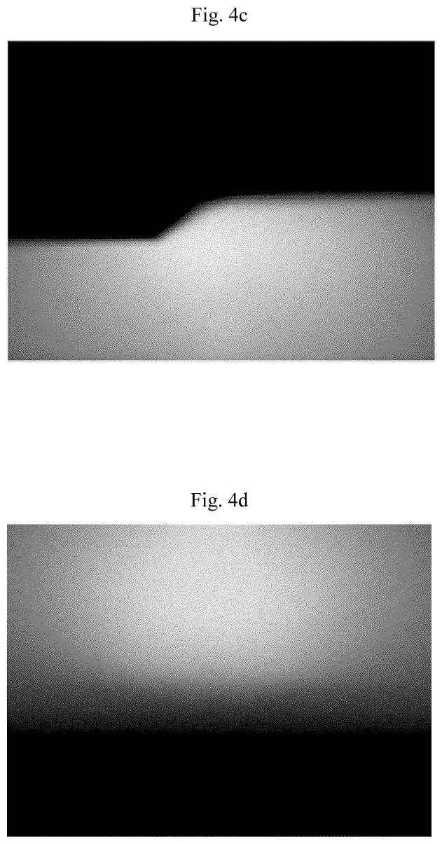

FIGS. 4a-4d are comparison diagrams of the light effects of a vehicle lamp module according to an embodiment of the present invention and a vehicle lamp module without a light blocker 105. FIGS. 4a and 4b are respectively light effect diagrams of the low beam and the high beam of the vehicle lamp module without a light blocker 105. FIGS. 4c and 4d are respectively light effect diagrams of the low beam and the high beam of the vehicle lamp module according to the present invention.

As can be seen from FIGS. 4a-4d, in the vehicle lamp module 100 according to the present invention, the light rays directly emitted from the light source 101 are blocked by the light blocker 105 arranged on the radiator 104, so that not only can virtual spots above a low-beam cut-off line be reduced, but the colored light can also be reduced in the high-beam area, and thus a good optical effect can be obtained.

The present invention also provides a motor vehicle headlamp, comprising the vehicle lamp module 100 described above.

In addition, the present invention also provides a motor vehicle, comprising the vehicle lamp module 100 or motor vehicle headlamp described above.

The motor vehicle headlamp or the motor vehicle according to the present invention has at least the beneficial effects brought about by the vehicle lamp module 100 described above.

For those skilled in the art, it is clear that the present invention is not limited to the details of the above exemplary embodiments, and the present invention can be implemented in other specific forms without departing from the spirit or essential features of the present invention. Thus, regardless of which viewpoint is taken, the embodiments should be regarded as being demonstrative and non-limiting; the scope of the present invention is defined by the attached claims and not by the explanation above, hence it is intended that all changes falling within the meaning and scope of equivalent key elements of the claims be included in the present invention. Any reference signs in the claims shall not be construed as limiting the claims concerned. In addition, it is obvious that the word “comprises” does not exclude other units or steps, and the singular does not exclude the plural. Words such as first and second are used to indicate designations, and do not indicate any specific order.

What is claimed is:

1. A vehicle lamp module, comprising: a light source, a reflector, a lens a light blocker, and a radiator, with
the reflector being arranged opposite to the light source and the reflector has a reflective surface for reflecting light rays emitted by the light source to form a light beam along an optical axis of the vehicle lamp module;
the lens is configured to project the light rays reflected by the reflector; and
the light source is arranged on the radiator, and the radiator dissipates heat from the light source.

2. The vehicle lamp module according to claim 1, wherein the light blocker is arranged between the light source and the lens.

3. The vehicle lamp module according to claim 2, wherein the light blocker is arranged on the radiator.

4. The vehicle lamp module according to claim 3, wherein the light blocker and the radiator are of an integral structure.

5. The vehicle lamp module according to claim 1, wherein the light blocker is arranged in one-to-one correspondence with the light source.

6. The vehicle lamp module according to claim 1, wherein when the vehicle lamp module includes a plurality of light sources, the light blocker is shared by more than one of the light sources.

7. The vehicle lamp module according to claim 6, in wherein the surface of the light blocker close to the light sources is a flat surface or a stepped surface.

8. A motor vehicle headlamp, comprising a vehicle lamp module, with the vehicle lamp module including a light source, a reflector, a lens, a light blocker, and a radiator, with
the reflector being arranged opposite to the light source, and the reflector has a reflective surface for reflecting light rays emitted by the light source to form a light beam along an optical axis of the vehicle lamp module;
the lens is configured to project the light rays reflected by the reflector; and
the light source is arranged on the radiator, and the radiator dissipates heat from the light source.

9. A motor vehicle, comprising a vehicle lamp module, with the vehicle lamp module including a light source, a reflector, a lens, a light blocker, and a radiator, with
the reflector being arranged opposite to the light source, and the reflector has a reflective surface for reflecting light rays emitted by the light source to form a light beam along an optical axis of the vehicle lamp module;
the lens is configured to project the light rays reflected by the reflector; and
the light source is arranged on the radiator, and the radiator dissipates heat from the light source.
